(19) United States
(12) Patent Application Publication
(10) Pub. No.: US 2011/0231598 A1
(43) Pub. Date: Sep. 22, 2011

(54) MEMORY SYSTEM AND CONTROLLER

(75) Inventor: Kosuke HATSUDA, Tokyo (JP)

(73) Assignee: KABUSHIKI KAISHA TOSHIBA, Tokyo (JP)

(21) Appl. No.: 12/835,377

(22) Filed: Jul. 13, 2010

(30) Foreign Application Priority Data
Mar. 19, 2010 (JP) 2010-065122

(51) Int. Cl. G06F 12/08; G06F 12/00

(52) U.S. Cl. 711/103; 711/136; 711/128; 711/E12.001; 711/E12.018; 711/E12.022; 711/118; 711/E12.008

(57) ABSTRACT

According to one embodiment, a memory system includes a first memory that is nonvolatile, a second memory, and a controller that performs data transfer between a host device and the first memory by using the second memory. The controller caches data of each write command transmitted from the host device in the second memory, and performs a first transfer of transferring the data of each write command, which is cached in the second memory, to the first memory while leaving a beginning portion at a predetermined timing.

### CROSS-REFERENCE TO RELATED APPLICATIONS

This application is based upon and claims the benefit of priority from the prior Japanese Patent Application No. 2010-065122, filed on Mar. 19, 2010; the entire contents of which are incorporated herein by reference.

### FIELD

Embodiments described herein relate generally to a memory system and a controller.

### BACKGROUND

A NAND-type flash memory (hereinafter, simply a NAND memory) that is a nonvolatile memory has advantages such as high speed and lightweight compared with a hard disk. Moreover, the NAND memory is easy to realize large capacity and high integration compared with other flash memories including a NOR-type flash memory. An SSD (Solid State Drive) on which the NAND memory having these characteristics is mounted attracts attention as a large-capacity external storage as an alternative to a magnetic disk device.

As one of the problems when replacing the magnetic disk device with the SSD on which the NAND memory is mounted, the number of times (number of times of access limits) that the NAND memory can be accessed for reading/writing (specially, writing) is small. One of the methods to solve this problem is to route through a memory (RAM) capable of performing high-speed read/write, such as a DRAM, before writing in the NAND memory. Specifically, the SSD stores small-capacity data transmitted from a host device in the RAM, and when it becomes possible to be handled as large-capacity data, the SSD writes the data stored in the RAM in the NAND memory in a large unit such as a block unit (for example, see Japanese Patent Application Laid-open No. 2008-33788).

Typically, emphasis is placed on a response speed to a read command from the host device or time required for completing read processing as a performance index related to the read processing of the SSD. In the above SSD including the RAM that temporarily stores data from the host device also, there is a demand for developing a technology for improving the response speed to the read command from the host device and a speed for reading.

### BRIEF DESCRIPTION OF THE DRAWINGS

FIG. 1 is a diagram illustrating a hardware configuration of an SSD according to a first embodiment;

FIG. 2 is a diagram explaining an operation when data is written from a host device;

FIG. 3 is a diagram explaining an operation when data is read out from the host device;

FIG. 4 is a diagram explaining time required for data transfer to the host device;

FIG. 5 is a diagram explaining a function configuration of the SSD in the first embodiment;

FIG. 6 is a diagram explaining a relationship between an LBA address and a tag information table and line information;

FIG. 7 is a diagram explaining a command management table;

FIG. 8 is a flowchart explaining an operation of the SSD in the first embodiment in write processing;

FIG. 9 is a flowchart explaining an operation of the SSD in the first embodiment in read processing;

FIG. 10 is a diagram explaining a function configuration of an SSD in a second embodiment;

FIG. 11 is a diagram explaining line information;

FIG. 12 is a flowchart explaining an operation of the SSD in the second embodiment in write processing;

FIG. 13 is a diagram explaining a function configuration of an SSD in a third embodiment;

FIG. 14 is a flowchart explaining an operation of the SSD in the third embodiment in write processing; and

FIG. 15 is a flowchart explaining beginning size determination processing.

### DETAILED DESCRIPTION

In general, according to one embodiment, a memory system includes a first memory that is nonvolatile, a second memory, and a controller that performs data transfer between a host device and the first memory by using the second memory. The controller caches data of each write command transmitted from the host device in the second memory, and performs a first transfer of transferring the data of each write command, which is cached in the second memory, to the first memory while leaving a beginning portion at a predetermined timing.

Exemplary embodiments of a memory system and a controller will be explained below in detail with reference to the accompanying drawings. The present invention is not limited to the following embodiments.

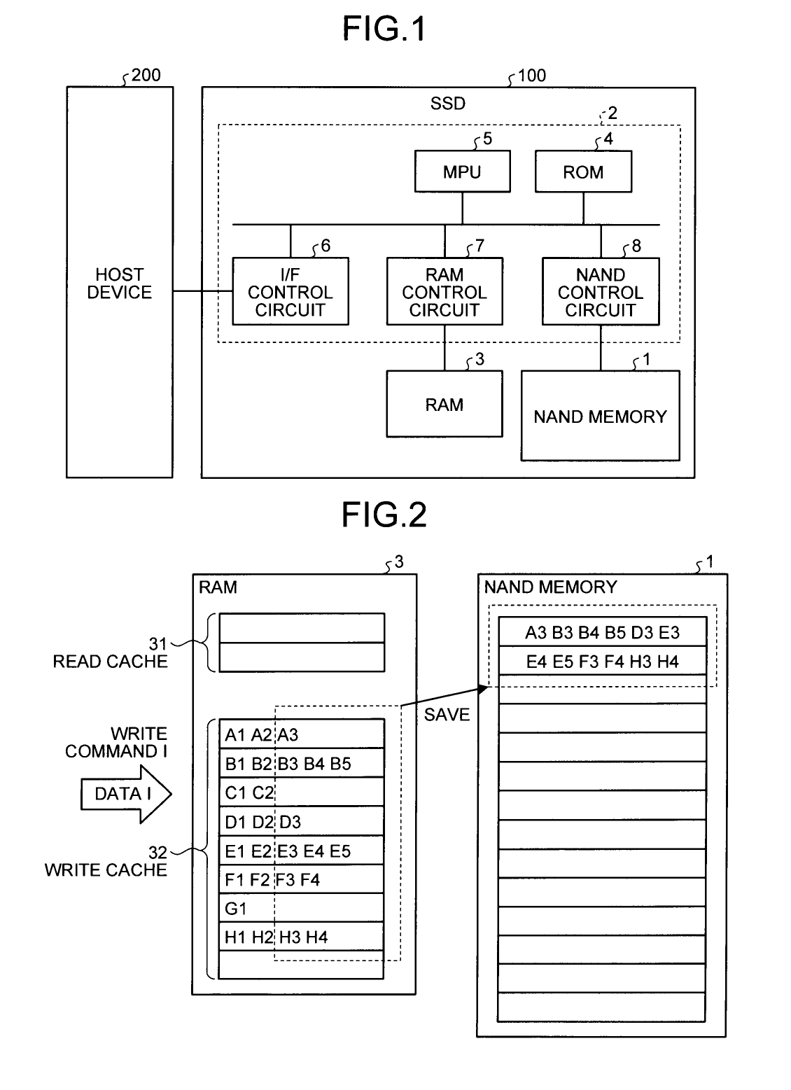

FIG. 1 is a diagram explaining a hardware configuration of a memory system. In a first embodiment, explanation is given taking an SSD as an example of the memory system, which includes a NAND-type flash memory (hereinafter, NAND flash memory) as a nonvolatile semiconductor memory and has a connection interface specification (ATA specification) same as a hard disk drive (HDD). The application range of the first embodiment is not limited to the SSD.

In FIG. 1, an SSD 100 and a host device 200 are connected via a communication interface conforming to the ATA specification. The SSD 100 receives a write command for writing user data and a read command for reading out the user data from the host device 200. The read command/write command includes a start LBA (Logical Block Addressing) address as a write address of the user data and a size of the user data. The user data that is requested to read/write by one read command/write command is, for example, one file and has a size that is natural number multiple of a size (for example, 512 Bytes) of a sector.

The SSD 100 includes a NAND memory chip that is a nonvolatile semiconductor memory chip, and includes a NAND memory 1 as a first memory in which the user data (hereinafter, data) to be read/written from the host device 200 is stored, a controller 2 that controls data transfer between the host device 200 and the NAND memory 1, and a RAM (Random Access Memory) 3 as a second memory in which data (write data) from the host device 200 is temporarily stored.

The controller 2 controls the NAND memory 1 and the RAM 3 to perform data transfer between the host device 200 and the NAND memory 1. The controller 2 further includes the following components as a configuration for performing this data transfer. Specifically, the controller 2 includes a ROM (Read Only Memory) 4, an MPU 5, an interface (I/F) control circuit 6, a RAM control circuit 7, and a NAND control circuit 8.

The I/F control circuit 6 transmits and receives the user data to and from the host device 200 via the ATA interface. The RAM control circuit 7 transmits and receives the user data to and from the RAM 3. The NAND control circuit 8 transmits and receives the user data to and from the NAND memory 1.

The ROM 4 stores a boot program that boots a management program (firmware) stored in the NAND memory 1. The MPU 5 boots the firmware and loads it in the RAM 3, and controls the whole controller 2 based on the firmware loaded in the RAM 3.

The RAM 3 functions as a cache for data transfer between the host device 200 and the NAND memory 1, a work area memory, and the like. As the RAM 3, it is possible to employ a DRAM (Dynamic Random Access Memory), an SRAM (Static Random Access Memory), an FeRAM (Ferroelectric Random Access Memory), an MRAM (Magnetoresistive Random Access Memory), an ReRAM (Resistance Random Access Memory), and the like. In the work area of the RAM 3, the firmware is loaded and various information (to be described later) for managing the cache is stored.

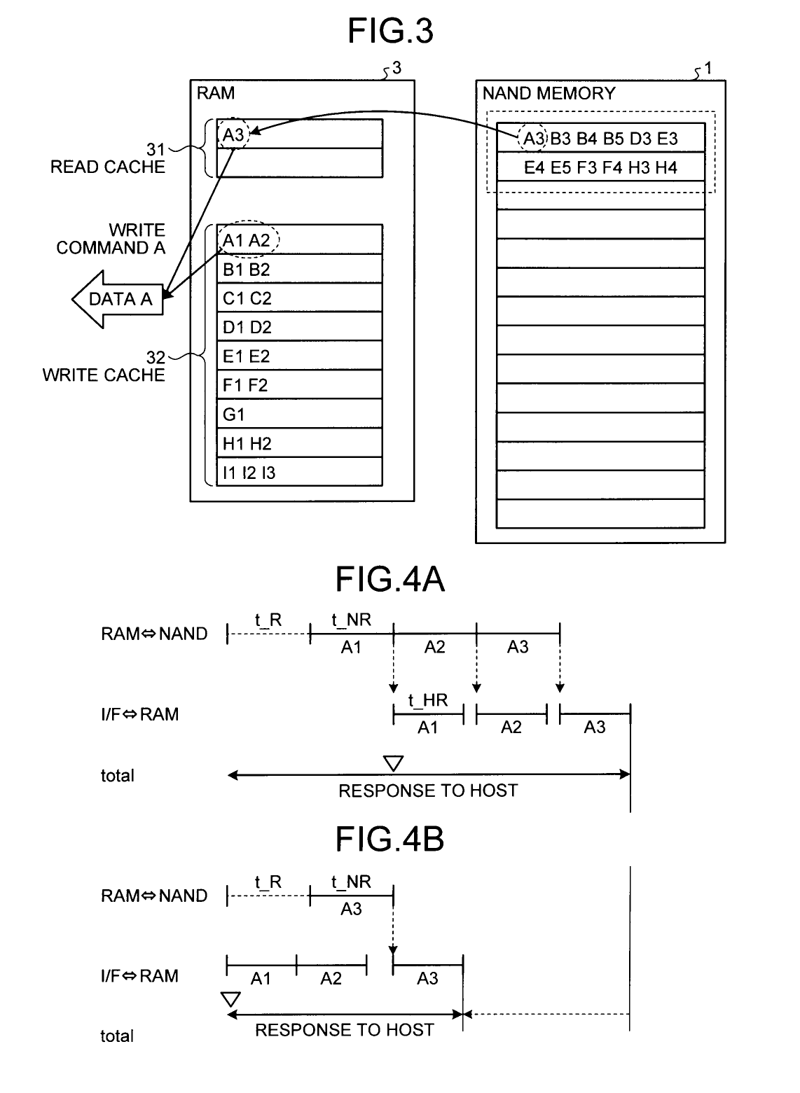

In the first embodiment of the present invention, a read processing performance is improved by utilizing the cache realized in the RAM 3. The characteristics of the first embodiment of the present invention are schematically explained with reference to FIG. 2 to FIG. 4. FIG. 2 is a diagram explaining an operation when data is written from the host device 200. FIG. 3 is a diagram explaining an operation when data is read out from the host device 200.

As shown in FIG. 2, the RAM 3 includes a write cache 32 in which data that is requested to write from the host device 200 is cached and a read cache 31 in which data read out from the NAND memory 1 is cached. The write cache 32 caches data A that is the write data by one write command (write command A). The data A includes data A1 to A3 in a page unit as a unit size in a write/read access to the NAND memory 1. In the similar manner, the write cache 32 caches data B to H in a write command unit, each of which is composed of data in a page unit, corresponding to write commands B to H, respectively. In the case of receiving a write command I for writing new data I from the host device 200, if the amount of data cached in the write cache 32 exceeds a predetermined threshold, the SSD 100 saves the cached write data of each write command in the NAND memory 1 while leaving data for beginning few pages (in this example, for 2 pages) (first transfer). For example, in the case of the data A, the data A1 and the data A2 are left and only the data A3 is saved in the NAND memory 1.

When performing readout of the user data, the host device 200 often performs a read request of data in a write command unit by one read command by specifying an LBA address and a data size same as those at the time of issuing the write command by the read command rather than performs the read request for partially reading out data in a write command unit. As shown in FIG. 3, when receiving a read command A from the host device 200 to read out the data A, the SSD 100 starts transferring the data A1 and A2 for beginning 2 pages of the data A cached in the write cache 32 to the host device 200, and reads out the remaining data A3 from the NAND memory 1 and caches the read out data A3 in the read cache 31. Then, after transferring the data A1 and A2 to the host device 200, the SSD 100 transfers the data A3 cached in the read cache 31.

FIG. 4 is a diagram explaining time required for transferring the data A to the host device 200 by comparing with a case (hereinafter, comparison example) where the write data is saved in the NAND memory 1 without separating into a beginning portion and a remaining portion. A read latency of the NAND memory 1 is denoted by t_R, a transfer time for 1 page from the NAND memory 1 to the RAM 3 is denoted by t_NR, and a transfer time for 1 page between the host device 200 and the RAM 3 is denoted by t_HR.

In the comparison example, as shown in FIG. 4A, when the read command A is received, the data A1 to A3 stored in the NAND memory 1 are sequentially read out to be stored in the write cache 32, and each of the data A1 to A3 starts to be transferred sequentially to the host device 200 after completing storing in the write cache 32. Therefore, the host device 200 receives a response after t_R+t_NR elapses from issuing of the read command A, and completes the read processing of the data A after t_R+3×t_NR+t_HR elapses. On the other hand, in the example in the first embodiment, as shown in FIG. 4B, when the read command A is issued, the SSD 100 starts transferring the data A1 from the write cache 32, so that the host device 200 can receive a response immediately after issuing the read command A. Then, the read processing of the data A is completed after t_R+t_NR+t_HR elapses from issuing of the read command A. In other words, according to the first embodiment, the response speed is improved and the time required for completing the read processing is shortened compared with the technology in the comparison example.

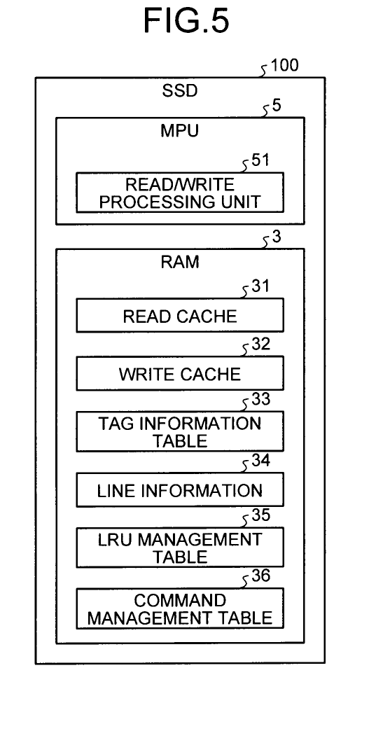

In this manner, the first embodiment is mainly characterized in that the beginning portion of data of each write command is left in the write cache as much as possible for improving the read processing performance. FIG. 5 is a diagram explaining a function configuration of the SSD 100 for realizing the above characteristics. As shown in FIG. 5, the MPU 5 includes a read/write processing unit 51 that performs control of write processing of performing storing of the write data in the write cache 32 and saving (transferring) of data from the write cache 32 in the NAND memory 1 in response to the write command and the read processing of transferring data pertaining to the read command from the write cache 32 and/or the NAND memory 1 to the host device 200 in response to the read command.

The RAM 3 stores a tag information table 33, line information 34 of each cache line, an LRU (Least Recently Used) management table 35, and a command management table 36 as information for managing the write cache 32, in addition to including the caches 31 and 32. These information can be stored in a storage unit other than the RAM 3. For example, a memory can be provided in or outside the controller 2 and the information can be stored in the memory.

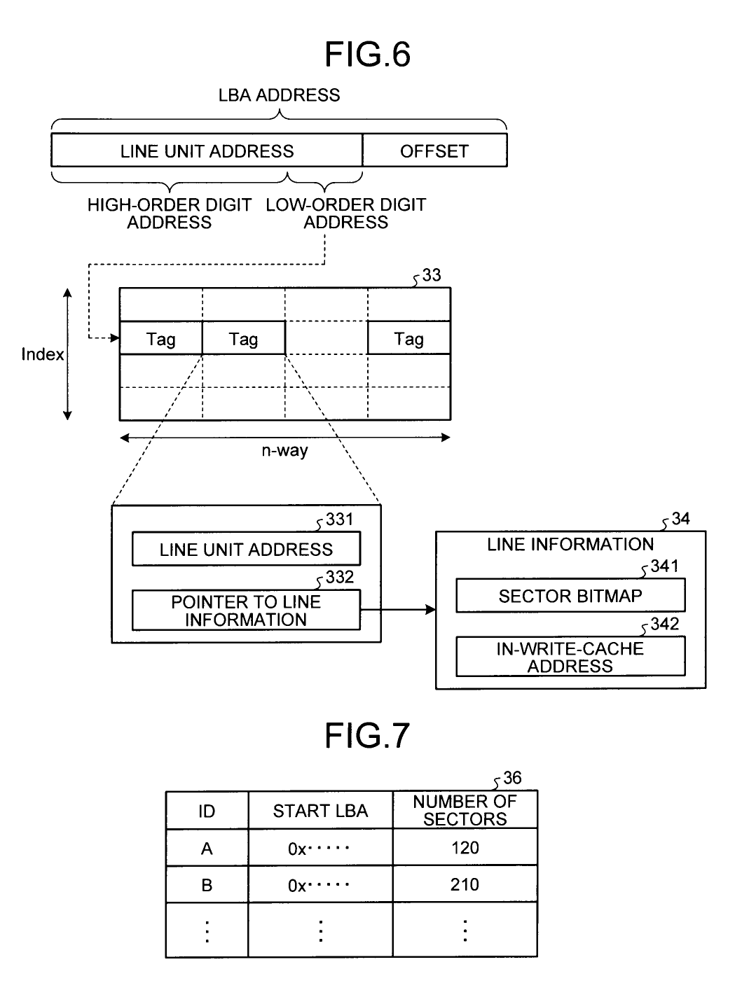

FIG. 6 is a diagram explaining a relationship between the LBA address and the tag information table 33 and the line information 34. As shown in FIG. 6, in the write cache 32, in order to specify data stored in each cache line, a line unit address obtained by excluding an offset for a size (line unit size) of the cache line from the LBA address is used. In other words, in the write cache 32, the cache line is managed based on the LBA address. Specifically, the tag information table 33 includes a plurality (n ways) of tags (Tag) for each index that is a few bits (low-order digit address) of an LSB of the line unit address. Each tag stores a line unit address 331 and a pointer 332 to the line information corresponding to the line unit address. The read/write processing unit 51 compares the line unit address of target data with the line unit address 331 stored in each tag with a low-order digit address of the line unit address as the index, thereby enabling to determine cache hit or cache miss of the target data. Although the line unit size is arbitrary, the line unit size in this example is explained to be equal to the page size. Moreover, explanation is given for a case where the tag information table 33 employs a set-associative that includes a plurality of tags for each index; however, a direct mapping that includes only one tag for each index can be employed.

The line information 34 corresponding to data (line unit data) stored in each cache line includes a sector bitmap 341 that indicates whether data of each sector included in the corresponding line unit data is valid or invalid and an in-write-cache address 342 that is a storage destination address of the line unit data in the write cache 32. In the case of the cache hit, the read/write processing unit 51 can recognize a storage location of target line unit data in the write cache 32 by referring to the in-write-cache address 342.

In the tag information table 33, the maximum number of the tags (number of ways) to be managed is determined for each index. When there is no available way of the index of the storage destination (when there is no available cache line), the read/write processing unit 51 flushes data stored in one of the cache lines of the same index to the NAND memory 1 to make room for the cache line (second transfer). The LRU management table 35 is a table that manages a flushing priority order of each tag for each index so that the flushing priority order is the highest for the oldest tag that is least recently accessed. The read/write processing unit 51 selects the oldest cache line as a flushing target based on the LRU management table 35.

FIG. 7 is a diagram explaining the command management table 36. As shown in FIG. 7, the command management table 36 is a table that manages the start LBA and the data size (number of sectors) of data that is written from the host device 200 for each write command. The read/write processing unit 51 can recognize (identify) the beginning portion for each data in a read command unit by referring to the command management table 36. Moreover, the read/write processing unit 51 can recognize the read command that the cache data of each cache line belongs to.

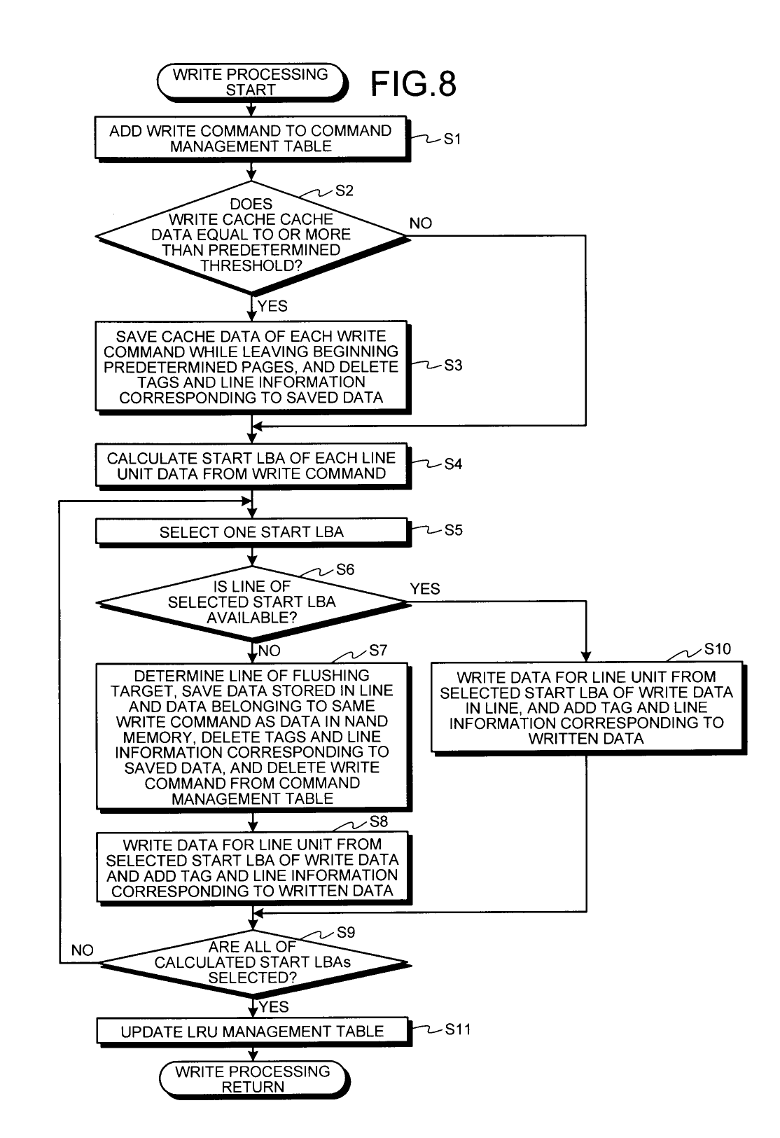

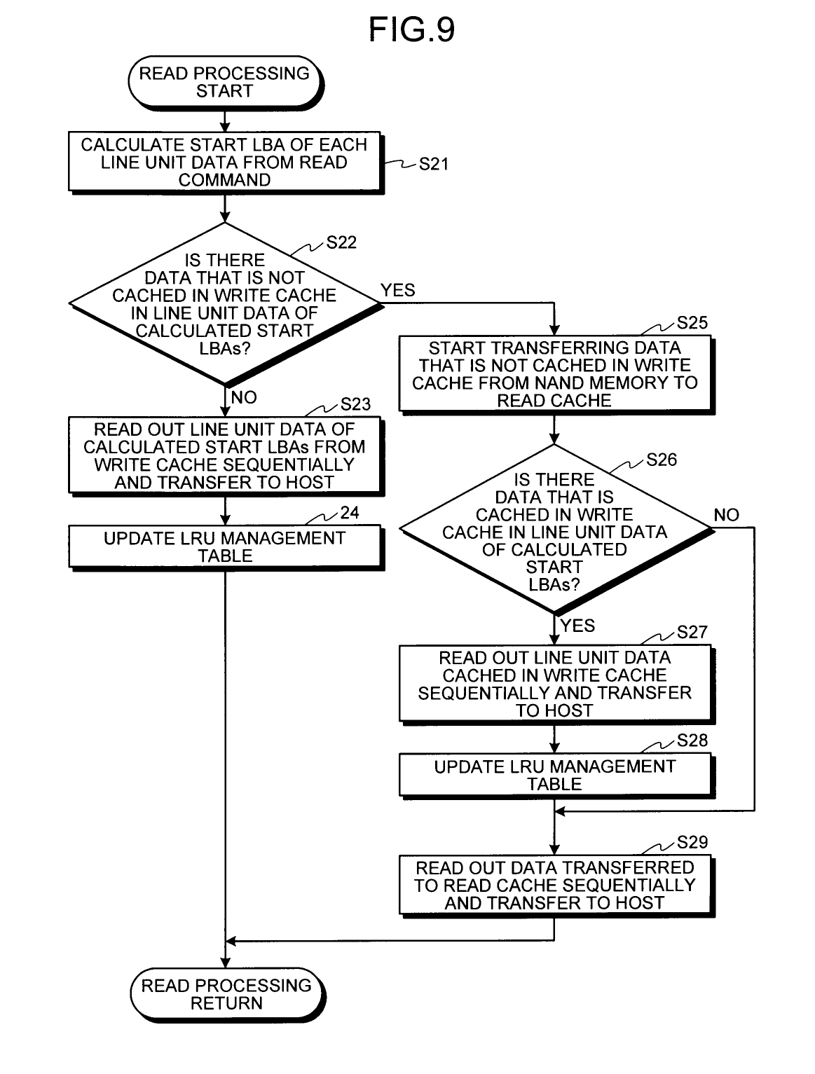

Next, an operation in the SSD 100 configured as above is explained with reference to FIG. 8 and FIG. 9.

FIG. 8 is a flowchart explaining the operation of the SSD 100 in the write processing. As shown in FIG. 8, when the write command is received and the write processing starts, the read/write processing unit 51 adds the received write command to the command management table 36 (Step S1). Then, the read/write processing unit 51 determines whether the write cache 32 caches data with the amount equal to or more than a predetermined threshold (Step S2).

When the write cache 32 caches data with the amount equal to or more than the predetermined threshold (Yes at Step 2), the read/write processing unit 51 refers to the command management table 36, saves the cache data of each write command in the NAND memory 1 while leaving beginning predetermined pages, and deletes the tags on the tag information table 33 and the line information 34 corresponding to the saved line unit data (Step S3). When the write cache 32 does not cache data with the amount equal to or more than the predetermined threshold (No at Step S2), the operation at Step S3 is skipped.

Next, the read/write processing unit 51 calculates the start LBA address of each line unit data for searching for the storage destination in the write cache 32 from the LBA address and the data size of the write command (Step S4), and selects one of the calculated start LBA addresses (Step S5). The start LBA address of each line unit data can be calculated by dividing an address value from the start LBA address included in the write command to an address value, which is obtained by adding the data size included in the write command to the start LBA address, into line unit size units. After Step S5, the read/write processing unit 51 determines whether the cache line corresponding to the selected start LBA address is available (Step S6). The read/write processing unit 51 searches the tag information table 33 by using the selected start LBA address, and determines that the cache line is available when the cache miss occurs and the cache line is not available when the cache hit occurs.

When the cache line is not available (No at Step S6), the read/write processing unit 51 determines the cache line of the flushing target by referring to the LRU management table 35, saves data stored in the cache line and data belonging to the same write command as the data in the NAND memory 1, and deletes the tags and the line information 34 corresponding to the saved data and deletes the write command that the saved data belongs to from the command management table 36 (Step S7). The read/write processing unit 51 can determine the data belonging to the same write command as the data stored in the cache line of the flushing target by referring to the command management table 36.

After Step S7, the read/write processing unit 51 writes data for the line unit size from the selected start LBA address of the write data in the cache line that become available by data flushing and adds the tag and the line information 34 corresponding to the written data (Step S8). Then, the read/write processing unit 51 determines whether all of the calculated start LBA addresses are selected (Step S9). When not all of the calculated start LBA addresses are selected (No at Step S9), the system control proceeds to Step S5 and selects one unselected start LBA address.

At Step S6, when the cache line corresponding to the selected start LBA address is available (Yes at Step S6), the read/write processing unit 51 writes data for the line unit size from the selected start LBA address of the write data in the line and adds the tag and the line information 34 corresponding to the written data (Step S10). Then, the system control proceeds to Step S9.

At Step S9, when all of the calculated start LBA addresses are selected (Yes at Step S9), the read/write processing unit 51 updates the LRU management table 35 so that the priority order of the tag corresponding to the written line unit data is the lowest among the tags in the same index (Step S11), and the write processing returns.

FIG. 9 is a flowchart explaining the operation of the SSD 100 in the read processing. In this example, a case is explained in which data in a write command unit is requested to read by the read command.

As shown in FIG. 9, when the read command is received and the read processing starts, the read/write processing unit 51 calculates the start LBA address of each line unit data from the read command (Step S21). Then, the read/write processing unit 51 searches the tag information table 33 for each calculated start LBA address to determine whether there is data that is not cached in the write cache 32 among the line unit data of the calculated start LBA addresses (Step S22). When there is no data that is not cached in the write cache 32 (No at Step 22), the read/write processing unit 51 sequentially reads out the line unit data of the calculated start LBA addresses from the write cache 32 and sequentially transfers the read out line unit data to the host device 200 (Step S23). Then, the read/write processing unit 51 updates the LRU management table 35 so that the priority order of the tag corresponding to the read out line unit data is the lowest among the tags in the same index (Step S24) and the read processing returns.

At Step S22, when there is data that is not cached in the write cache 32 (Yes at Step S22), the read/write processing unit 51 starts transferring the line unit data that is not cached in the write cache 32 from the NAND memory 1 to the read cache 31 (Step S25). Then, the read/write processing unit 51 searches the tag information table 33 for each calculated start LBA address to determine whether there is data (i.e., beginning portion of data that is requested to read by the read command) that is cached in the write cache 32 among the line unit data of the calculated start LBA addresses (Step S26). When there is data that is cached in the write cache 32 (Yes at Step S26), the read/write processing unit 51 sequentially reads out the data cached in the write cache 32 and transfer the data to the host device 200 (Step S27). Then, the read/write processing unit 51 updates the LRU management table 35 so that the priority order of the tag corresponding to the read out line unit data is the lowest among the tags in the same index (Step S28). Then, after completing transfer of the cached data, the read/write processing unit 51 sequentially reads out the data transferred to the read cache 31 and transfers the data to the host device 200 (Step S29), and the read processing returns. At Step S26, when there is no data cached in the write cache 32 (No at Step S26), Step S27 and Step S28 are skipped.

It is applicable to omit the LRU management table 35, determine data in a command unit having the largest size by referring to the tag information table 33 and the command management table 36, and flush the determined data in a command unit. For example, when reading out the data A in a write command unit with a size of 3 pages from the NAND memory 1, the elapse time for obtaining a response is t_R+t_NR, and the elapse time for completing the read processing is t_R+3t_NR+t_HR. Moreover, when reading out the data B in a write command unit with a size of 5 pages from the NAND memory 1, the elapse time for obtaining a response is equivalent to the case of the data A, and the elapse time for completing the read processing is t_R+5t_NR+t_HR. In other words, the effect of slowness of the response with respect to the time required for completing the read processing becomes relatively small as the size of the data becomes large. Therefore, the read processing performance can be further improved by preferentially saving data in a command unit with a larger size in the NAND memory 1 compared with the case of saving data simply based on the LRU rule.

Moreover, instead of the LRU management table 35, it is applicable to include a table that manages the flushing priority order of each tag for each index so that the priority order becomes high for the cache line storing data with high write efficiency and select the cache line storing data with the highest write efficiency as the flushing target by the read/write processing unit 51 based on the table.

Furthermore, it is explained that data is flushed in a command unit; however, data can be flushed in a line unit. When data is flushed in a command unit, the data amount to be cached in the write cache 32 can be reduced compared with the case of flushing data in a line unit and therefore frequency of the save processing at Step S3 and the flush processing at Step S7 can be reduced.

Moreover, although setting of the size of the beginning portion left in the write cache 32 is arbitrary, if the setting value of the size of the beginning portion is too large, the data amount cached in the write cache 32 becomes large, which leads to increasing frequency of the save processing at Step S3 and the flush processing at Step S7, resulting in lowering the write processing performance. Therefore, it is preferable that the size of the remaining beginning portion be not made large needlessly and be made to the size of the degree to substantially cover the time t_R+t_NR required for the first data read out from the NAND memory 1 to be transferred to the host device 200.

Furthermore, a case is explained in which the SSD 100 performs the save processing at Step S3 when the data amount cached in the write cache 32 exceeds the predetermined threshold; however, the timing to perform the save processing can be arbitrary. For example, the save processing can be performed constantly.

Moreover, when the nonvolatile memory such as the FeRAM is employed as the RAM 3, it is applicable that a flag indicating valid/invalid of the line unit data is added to each tag and the flag is made invalid when the saving and the flushing of the line unit data are performed to treat the line unit data as deleted.

As explained above, according to the first embodiment of the present invention, data of each write command transmitted from the host device 200 is cached in the write cache 32 included in the RAM 3, and the data of each write command cached in the write cache 32 is transferred to the NAND memory 1 while leaving the beginning portion at a predetermined timing, so that the beginning portion cached in the write cache 32 can be immediately transferred to the host device 200 when receiving the read command from the host device 200. Therefore, the response to the read command becomes fast and the time required for completing the read processing is shortened. In other words, the read processing performance can be improved as much as possible.

In order to improve a hit rate of the write cache in the read processing, a second embodiment is characterized in that when the cache data is saved from the write cache in the NAND memory, a copy of the saved data is left in the write cache.

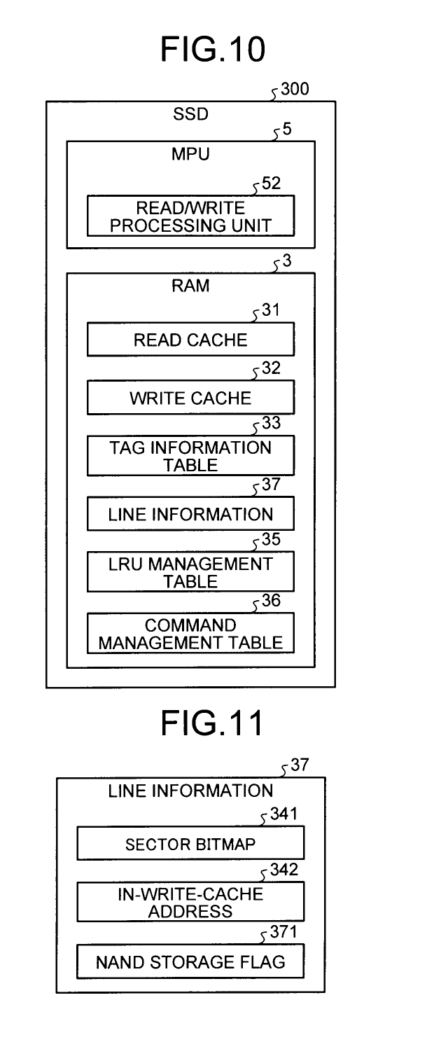

A hardware configuration of an SSD 300 in the second embodiment is equivalent to that in the first embodiment, so that explanation thereof is omitted. FIG. 10 is a diagram explaining a function configuration of the SSD 300 in the second embodiment. In this example, components equivalent to those in the first embodiment are given the same reference numerals and detailed explanation thereof is omitted.

As shown in FIG. 10, the MPU 5 includes a read/write processing unit 52 that performs control of the read processing and the write processing of the SSD 300. The RAM 3 stores the tag information table 33, line information 37, the LRU management table 35, and the command management table 36, in addition to including the caches 31 and 32.

FIG. 11 is a diagram explaining the line information 37. As shown in FIG. 11, the line information 37 includes the sector bitmap 341, the in-write-cache address 342, and a NAND storage flag 371. The NAND storage flag 371 is used for determining whether the corresponding line unit data is copied to the NAND memory 1.

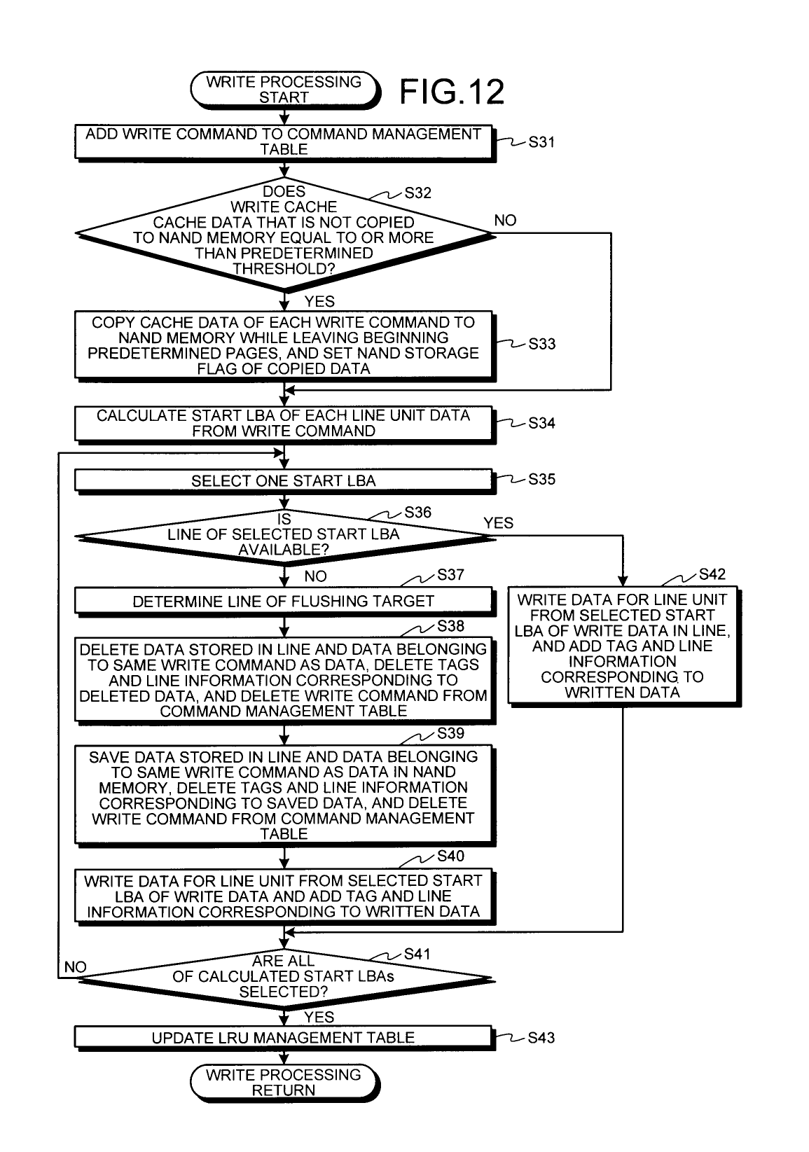

FIG. 12 is a flowchart explaining an operation of the SSD 300 in the write processing. As shown in FIG. 12, when the write command is received and the write processing starts, the read/write processing unit 52 adds the received write command to the command management table 36 (Step S31). Then, the read/write processing unit 52 determines whether the write cache 32 caches data with the amount equal to or more than a predetermined threshold (Step S32).

When the write cache 32 caches data with the amount equal to or more than the predetermined threshold (Yes at Step 32), the read/write processing unit 52 refers to the command management table 36, copies the cache data of each write command to the NAND memory 1 while leaving beginning predetermined pages (i.e., transfers the cache data of each write command to the NAND memory 1 while leaving the beginning predetermined pages and leaves the copy of the transferred data in the original cache line), and sets the NAND storage flag 371 corresponding to the copied cache data (Step S33). When the write cache 32 does not cache data with the amount equal to or more than the predetermined threshold (No at Step S32), the operation at Step S33 is skipped.

Next, the read/write processing unit 52 calculates the start LBA address of each line unit data for searching for the storage destination in the write cache 32 from the LBA address and the data size of the write command (Step S34), and selects one of the calculated start LBA addresses (Step S35). Then, the read/write processing unit 52 determines whether the cache line corresponding to the selected start LBA address is available based on the tag information table 33 (Step S36).

When the cache line is not available, (No at Step S36), the read/write processing unit 52 determines the cache line of the flushing target by referring to the LRU management table 35 (Step S37). Then, the read/write processing unit 52 deletes data in which the NAND storage flag 371 is set among data stored in the cache line of the flushing target and data belonging to the same write command as the data, deletes the tags and the line information 37 corresponding to the deleted data, and deletes the write command that the deleted data belongs to from the command management table 36 (Step S38). Moreover, the read/write processing unit 52 saves data in which the NAND storage flag 371 is not set to the NAND memory 1 among the data stored in the cache line of the flushing target and the data belonging to the same write command as the data, deletes the tags and the line information 37 corresponding to the saved data, and deletes the write command that the saved data belongs to from the command management table 36 (Step S39).

Then, the read/write processing unit 52 writes data for the line unit size from the selected start LBA address of the write data in the cache line that becomes available by data flushing and adds the tag and the line information 37 corresponding to the written data (Step S40). Then, the read/write processing unit 52 determines whether all of the calculated start LBA addresses are selected (Step S41). When not all of the calculated start LBA addresses are selected (No at Step S41), the system control proceeds to Step S35 and selects one unselected LBA address.

At Step S36, when the cache line corresponding to the selected start LBA address is available (Yes at Step S36), the read/write processing unit 52 writes data for the line unit size from the selected start LBA address of the write data in the line and adds the tag and the line information 37 corresponding to the written data (Step S42). Then, the system control proceeds to Step S41.

At Step S41, when all of the calculated start LBA addresses are selected (Yes at Step S41), the read/write processing unit 52 updates the LRU management table 35 so that the priority order of the tag corresponding to the written line unit data is the lowest among the tags in the same index (Step S43), and the write processing returns.

In this manner, according to the second embodiment, it is configured such that the copy of data of each write command already transferred to the NAND memory 1 is left in the cache line in which the data was cached, and when the cache line becomes a cache destination for new data of each write command unit, the data of each write command cached in the cache line is deleted. Therefore, the amount of cached data is increased compared with the first embodiment, which results in improving the hit rate of the write cache 32 at the time of the read processing.

As described above, in the case where the size of data in a write command unit is large, if the data is saved in the NAND memory 1 in priority to data with a small size, the read processing performance is improved compared with the case where the priority order in accordance with the size is not provided. Thus, in a third embodiment, the size of the beginning portion left in the write cache is changed according to the size of data in a write command unit.

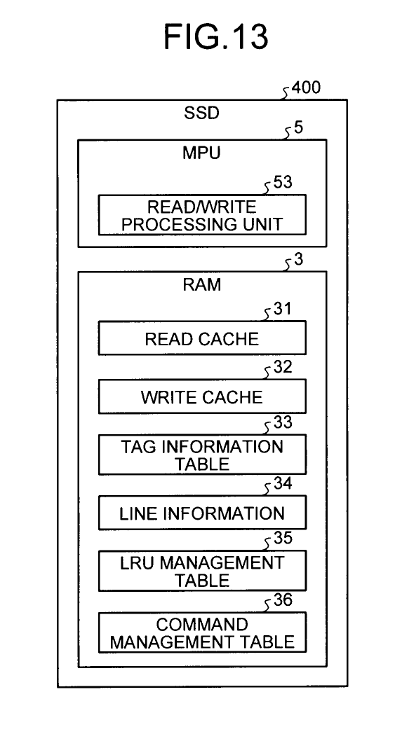

FIG. 13 is a diagram explaining a function configuration of an SSD 400 in the third embodiment. As shown in FIG. 13, the MPU 5 includes a read/write processing unit 53 that performs control of the read processing and the write processing of the SSD 400. The RAM 3 stores the tag information table 33, the line information 34, the LRU management table 35, and the command management table 36, in addition to including the caches 31 and 32.

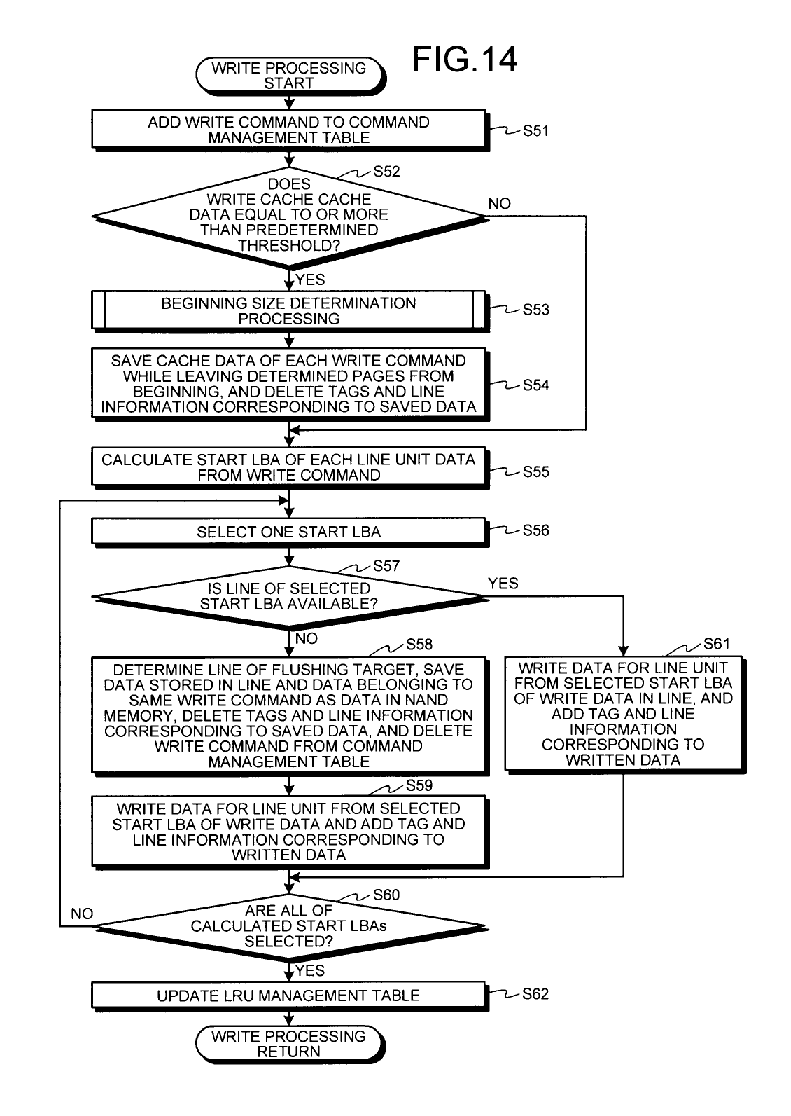

FIG. 14 is a flowchart explaining an operation of the SSD 400 in the third embodiment in the write processing. As shown in FIG. 14, when the write command is received and the write processing starts, the read/write processing unit 53 adds the received write command to the command management table 36 (Step S51). Then, the read/write processing unit 53 determines whether the write cache 32 caches data with the amount equal to or more than a predetermined threshold (Step S52).

When the write cache 32 caches data with the amount equal to or more than the predetermined threshold (Yes at Step 52), the read/write processing unit 53 performs beginning size determination processing for determining the size of the beginning portion to be left in the write cache 32 (Step S53).

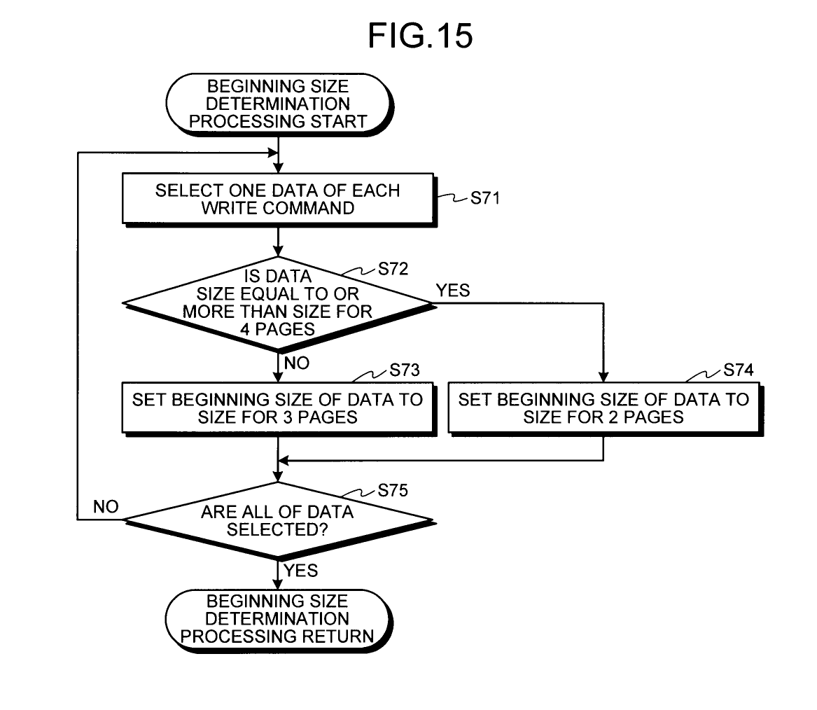

FIG. 15 is a flowchart explaining an example of the beginning size determination processing. As shown in FIG. 15, the read/write processing unit 53 refers to the command management table 36 and selects one piece of data of each write command (Step S71). Then, the read/write processing unit 53 determines whether the data size of the selected data is equal to or more than the size for 4 pages (Step S72). When the data size of the selected data is less than the size for 4 pages (No at Step S72), the read/write processing unit 53 sets the beginning size of the data to the size for 3 pages (Step S73). When the data size of the selected data is equal to or more than the size for 4 pages (Yes at Step S72), the beginning size of the data is set to the size for 2 pages (Step S74). Then, the read/write processing unit 53 determines whether all of the data is selected (Step S75). When there is unselected data (No at Step S75), the system control proceeds to Step S71 and selects one piece of the unselected data. When all of the data are selected (Yes at Step S75), the beginning size determination processing returns.

In this example, the size of the beginning portion is determined based on whether the data size is the size for 4 pages; however, the threshold used for distinguishing the size of the beginning portion can be other than four. Moreover, it is applicable that two or more thresholds are used to classify into three or more cases and a different size is determined depending on each classified case. Furthermore, explanation is given for the case of determining the size of the beginning portion to the size for 2 pages or 3 pages; however, the size of the beginning portion is not limited to these sizes.

In this manner, the size of the beginning portion left in the write cache 32 is made larger as the size of the write data is smaller.

Returning to FIG. 14, after the beginning size determination processing, the read/write processing unit 53 saves the cache data of each write command in the NAND memory 1 while leaving the beginning predetermined pages and deletes the tags on the tag information table 33 and the line information 34 corresponding to the saved line unit data (Step S54). Then, at Step S55 to Step S62, the SSD 400 performs the operation equivalent to that at Step S4 to Step S11 in the first embodiment, and the write processing returns.

In the above explanation, the beginning size determination processing is performed when it is determined that the write cache 32 caches data with the amount equal to or more than the predetermined threshold; however, the timing to perform the beginning size determination processing is not limited to the timing after the determination.

In this manner, it is configured such that the size of the beginning portion to be left in the write cache 32 is made larger as the size of the write data is smaller, so that when the size of data in a write command unit is large, the data can be saved in the NAND memory 1 in priority to data with a small size, enabling to improve the read processing performance.

While certain embodiments have been described, these embodiments have been presented by way of example only, and are not intended to limit the scope of the inventions. Indeed, the novel devices and systems described herein may be embodied in a variety of other forms; furthermore, various omissions, substitutions and changes in the form of the devices and systems described herein may be made without departing from the sprit of the inventions. The accompanying claims and their equivalents are intended to cover such forms or modifications as would fall within the scope and spirit of the inventions.

What is claimed is:

1. A memory system comprising:
a first memory that is nonvolatile;
a second memory; and
a controller that performs data transfer between a host device and the first memory by using the second memory, wherein
the controller caches data of each write command transmitted from the host device in the second memory, and performs a first transfer of transferring the data of each write command, which is cached in the second memory, to the first memory while leaving a beginning portion at a predetermined timing.

2. The memory system according to claim 1, wherein the predetermined timing is timing at which an amount of the data cached in the second memory exceeds a predetermined threshold.

3. The memory system according to claim 1, wherein the controller performs management of a cache line based on a write address included in the write command.

4. The memory system according to claim 3, further comprising a command-management-table storage unit that stores a command management table that manages the write address and a data size included in each write command for each data of each write command cached in the second memory, wherein
the controller, when performing the first transfer, identifies the beginning portion in the data of each write command based on the command management table.

5. The memory system according to claim 3, wherein in a case of caching new data, when a cache line of a cache destination for the data is not available, the controller performs a second transfer of transferring data cached in the cache line to the first memory.

6. The memory system according to claim 5, further comprising a command-management-table storage unit that stores a command management table that manages the write address and a data size included in each write command for each data of each write command cached in the second memory, wherein
the controller, when performing the second transfer, determines data belonging to same write command as the data cached in the cache line to be a target for the second transfer by referring to the command management table and transfers determined data to the first memory.

7. The memory system according to claim 5, wherein
the management of the cache line is management of the cache line based on a set-associative, and
the controller selects the cache line to be a target for the second transfer based on an LRU (Least Recently Used) rule.

8. The memory system according to claim 7, further comprising a command-management-table storage unit that stores a command management table that manages the write address and a data size included in each write command for each data of each write command cached in the second memory, wherein
the controller, when performing the second transfer, determines data belonging to same write command as the data cached in the cache line to be a target for the second transfer by referring to the command management table and transfers determined data to the first memory.

9. The memory system according to claim 5, wherein
the management of the cache line is management of the cache line based on a set-associative,
the memory system further includes a command-management-table storage unit that stores a command management table that manages the write address and a data size included in each write command for each data of each write command cached in the second memory, and
the controller selects a cache line that caches data of each write command having a largest size as a target for the second transfer based on the command management table.

10. The memory system according to claim 9, wherein the controller, when performing the second transfer, determines data belonging to same write command as the data cached in the cache line to be a target for the second transfer by referring to the command management table and transfers determined data to the first memory.

11. The memory system according to claim 3, wherein the controller, when performing the first transfer, leaves a copy of data of each write command that is already transferred to the first memory in a cache line in which the data was cached, and when the cache line becomes a cache destination for new data, deletes the data that was cached in the cache line.

12. The memory system according to claim 11, wherein further comprising a flag storage unit that stores a flag for indentifying whether the data cached in the second memory is already subjected to the first transfer, for each cache line, wherein
the controller determines whether data stored in the cache destination is copied data based on the flag.

13. The memory system according to claim 1, wherein the controller, when performing the first transfer, determines a size of the beginning portion to be left in the second memory for each data of each write command cached in the second memory so that the size of the beginning portion to be left in the second memory becomes large as a size of the data of each write command is small.

14. The memory system according to claim 13, further comprising a command-management-table storage unit that stores a command management table that manages a write address and a data size included in each write command for each data of each write command cached in the second memory, wherein
the controller determines the size of the beginning portion to be left in the second memory for each data of each write command based on the command management table.

15. A controller that is mounted on a memory system including a first memory that is nonvolatile and a second memory and that performs data transfer between a host device and the first memory by using the second memory, wherein
the controller caches data of each write command transmitted from the host device in the second memory, and performs a first transfer of transferring the data of each write command, which is cached in the second memory, to the first memory while leaving a beginning portion at a predetermined timing.

16. The controller according to claim 15, wherein management of a cache line is performed based on a write address included in the write command.

17. The controller according to claim 16, wherein, in a case of caching new data, when a cache line of a cache destination for the data is not available, a second transfer of transferring data cached in the cache line to the first memory is performed.

18. The controller according to claim 16, wherein
a command management table for managing the write address and a data size included in each write command for each data of each write command cached in the second memory is managed, and
the beginning portion in the data of each write command is identified based on the command management table when performing the first transfer.

19. The controller according to claim 16, wherein, when performing the first transfer, a copy of data of each write command that is already transferred to the first memory is left in a cache line in which the data was cached, and when the cache line becomes a cache destination for new data, the data that was cached in the cache line is deleted.

20. The controller according to claim 15, wherein, when performing the first transfer, a size of the beginning portion to be left in the second memory for each data of each write command cached in the second memory is determined so that the size of the beginning portion to be left in the second memory becomes large as a size of the data of each write command is small.
